(19) United States
(12) Patent Application Publication
(10) Pub. No.: US 2013/0283263 A1
(43) Pub. Date: Oct. 24, 2013

(54) SYSTEM AND METHOD FOR MANAGING RESOURCES IN A VIRTUAL MACHINE ENVIRONMENT

(71) Applicant: Walid H. Elemary, Vista, CA (US)

(72) Inventor: Walid H. Elemary, Vista, CA (US)

(73) Assignee: DINCLOUD, INC., Los Angeles, CA (US)

(21) Appl. No.: 13/450,717

(22) Filed: Apr. 19, 2012

(51) Int. Cl. G06F 9/455; G06F 15/16; G06F 17/30

(52) U.S. Cl. 718/1

(57) ABSTRACT

A system and method for assigning attributes, such as directory or firewall attributes for virtual machines by a user over a network comprising an input server connected to a network and programmed to present an interface to a user over a network, the interface configured to receive inputs from the user comprising attributes for a virtual machine and to store the input directory attributes in a database, a database for storing the directory attributes, and a controller programmed to periodically poll the database for updates and creates a daemon thread. A directory agent then accesses the thread and inputs the updated attributes into the operating system program of the virtual machine.

### TECHNICAL FIELD

This invention generally relates to a method and system for allowing a user to identify, select and automatically allocate resources, including software programs, processing capability, and disk and other storage capacity and to assign directory attributes to a virtual machine via a remote virtual machine installation client over a network.

### BACKGROUND OF THE INVENTION

As is well known in the field of computer science, a virtual machine (VM) is a virtualization of an actual physical computer system which is installed as a “client” on a “host” hardware platform. Typically, the hardware platform includes one or more processors (CPUs), system memory, generally some form of high-speed RAM, and a storage device, which will often comprise a disk non-volatile, mass storage device. The hardware will also include other conventional mechanisms such as a memory management unit, various registers, and any conventional network connection device, such as a network adapter or network interface card, for transfer of data between the various components of the system and a local or wide-area network such as the Internet.

Each VM will typically include at least one virtual CPU, a virtual disk, a virtual system memory, and a client operating system (which may simply be a copy of a conventional operating system). All of these components of the VM may be implemented in software using known techniques to emulate the corresponding components of an actual computer.

If the VM is properly designed, it will not be apparent to the user that any applications running within the VM are running indirectly, that is, via the client OS and virtual processor. Applications running within the VM will act just as they would if run on a “real” computer. Executable files will be accessed by the guest OS from the virtual disk or virtual memory, which will simply be portions of the actual host physical disk or memory allocated to that VM. Once an application is installed within the VM, the client OS retrieves files from the virtual disk just as if they had been pre-stored as the result of a conventional installation of the application. The design and operation of VMs is well known in the field of computer science.

Some interface is usually required between a VM and the underlying host platform (in particular, the CPU), which is responsible for actually executing VM-issued instructions and transferring data to and from the actual memory and storage devices. A common term for this interface is a “virtual machine monitor” (VMM), usually a thin piece of software that runs directly on top of a host, or directly on the hardware, and virtualizes all the resources of the physical host machine. Among other components, the VMM usually includes device emulators which may constitute the virtual devices that the VM addresses. The interface exported to the VM is then the same as the hardware interface of the machine, so that the client OS cannot determine the presence of the VMM.

In such systems for hosting of virtual desktops and other computer applications, provisioning platforms are typically used to permit a user to select, configure, and distribute selected software and processing capabilities from the host's centralized provisioning server to VMs on a network. In such systems, implementing the selections may require additional manual operations on the part of the system host, such as allocating the available resources, including software programs, processing capability, and disk and other storage capacity to each machine deployed on the network. Assigning directory attributes may also require additional manual operations on the part of the system host. Additionally, the user my not be aware of the level of utilization of the resources dedicated to each VM, leading to inefficient allocation of such resources in that some machines may have capabilities in excess of their usage, while others may have user demands which frequently exceed the dedicated resources. Further, the process of completing the billing to the user may require substantial manual inputs and operations by the system host, and this burden may be compounded in the case where the hosted resources are provided through a distribution partner which may be entitled to share in the revenues generated from the hosting services provided to the user.

### SUMMARY OF THE INVENTION

The present invention provides a host and user with a system and method for quickly and efficiently allocating hosted system resources, including software programs, processing capability, and disk and other storage capacity to a VM via a remote VM installation client over a network. The present invention may also be used to provide a host and user with a system and method for quickly and efficiently assigning directory attributes for VMs. The present invention may also be used to provide reports to the user and/or host which depict the level of utilization of each of the resources dedicated to each VM, thus promoting optimum allocation of such resources.

The present invention also provides a system for automatically preparing invoices and other billing information based upon the user's resources dedicated to each VM. The present invention may also be used to support the initiation, selection and delivery of hosted resources through one or more distribution partners of the host. In such distribution arrangement, the partner may be entitled to share in the revenues generated from the hosting services provided to the user. In one aspect of the present invention, a system is provided to automatically track the hosting services provided through such distribution partner, and to determine if the partner qualifies to share in the revenues generated from the hosting services provided to the user based upon the level of the revenues. If the partner qualifies, the system may automatically prepare payment invoices to the partner based upon a predetermined share in the revenues generated from the hosting services provided to the user.

In one preferred embodiment the system and method of the present invention provide automated management of host services, including user management, VMs provisioning automation, firewall-based security automation, orders, invoices, reports, etc. The automation “controller” server receives user inputs from a GUI on the user's computer or other input device, such as a mobile device or smartphone, and automates the provisioning process. The provisioning process can entail, for example, the assignment of physical host among hundreds of available hosts based on the datacenter selected by the user, the network automation for that user's VMs, the memory storage assignment to the VMs, the selection and delivery of an operating system to the user's set of VMs, as well as the installation of application or other selected software. Additionally, the controller may automate security provisioning upon a single input (click) by the user, and automatically upgrade or downgrade the VM's assigned resources and browser based console connectivity to their hosted virtual desktops.

In another preferred embodiment the system and method of the present invention provide automated management of assigning directory attribute to one or more VMs. The controller server receives user inputs from a GUI on the user's computer or other input device and automates the assignment of directory attributes. The assignment process can entail, for example, the assignment of network configuration data selected by the user, including domain name services, into the Windows 7 or other operating system program used by the VM.

### BRIEF DESCRIPTION OF THE DRAWINGS

FIG. 1 is a simplified diagram illustrating the VM environment of a preferred embodiment of the present invention.

FIG. 2 is an illustration of the system architecture of a preferred embodiment of the present invention.

FIG. 3 is a flow chart illustrating the VM secured remote view function of a preferred embodiment of the present invention.

FIG. 4 is a flow chart illustrating the automated task management process performed by the controller of a preferred embodiment of the present invention.

FIG. 5 is a flow diagram which illustrates the active directory function in accordance with the present invention.

FIG. 6 is an illustration of a user input screen of a preferred embodiment of the present invention.

FIG. 7 is an illustration of a user input screen of a preferred embodiment of the present invention.

### DETAILED DESCRIPTION OF THE PREFERRED EMBODIMENTS

Reference is now made to the figures in which like reference numerals refer to like elements.

In the following description, certain specific details of programming, software modules, user selections, network transactions, database queries, database structures, etc., are provided for a thorough understanding of the embodiments of the invention. However, those skilled in the art will recognize that the invention can be practiced without one or more of the specific details, or with other methods, components, materials, etc.

In some cases, well-known structures, materials, or operations are not shown or described in detail in order to avoid obscuring aspects of the invention. Furthermore, the described features, structures, or characteristics may be combined in any suitable manner in one or more embodiments.

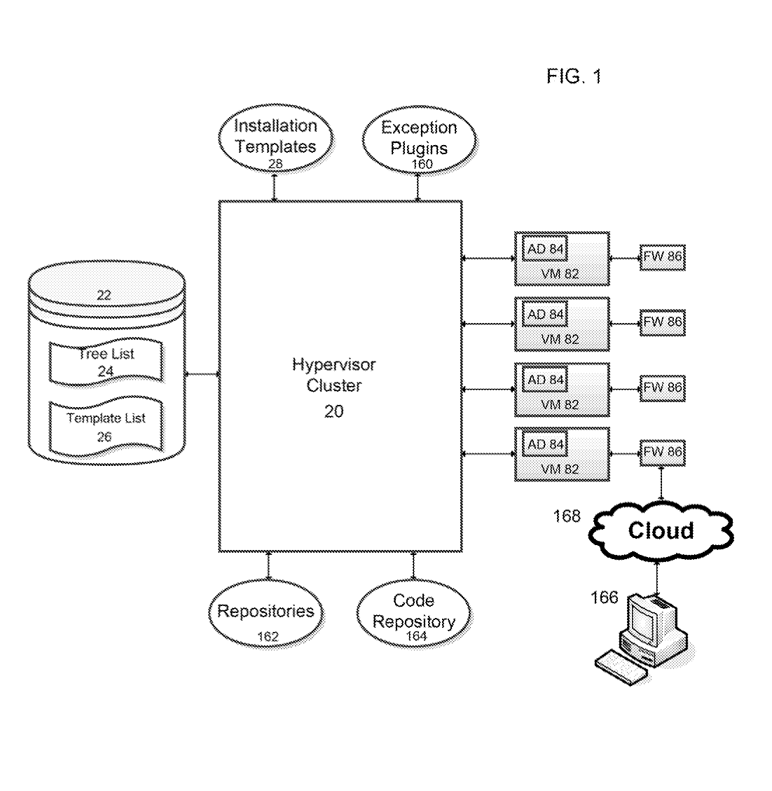

According to exemplary aspects illustrated in FIG. 1 the provisioning system in the VM environment of a preferred embodiment of the present invention can include a provisioning server 20, repositories 162, a code repository 164 which provides access to distributions, a set of installation templates 28, a set of exception plugins 160, an agent 84 as part of virtual machine 82 running on client machines 166 in a network 168 and protected by firewall 86, and a provisioning database 22 which comprises a distribution tree list 24 and template list 26.

The provisioning server, also known as a “hypervisor cluster,” 20, such as an Esxi Host server, is responsible for: serving as a extensible markup language remote procedure call (XMLRPC) handler; linking to or mirroring install distribution trees and a configuration database; hosting kickstart templates; hosting plugins, generating installation images, and the like. The hypervisor cluster 20 can be implemented as software, such as Python code, installed on a boot server machine and provides a command line interface for configuration of the boot server. In addition, the hypervisor cluster 20 can make itself available as a Python application programming interface (API) for use by management software of the present invention.

The code repository 164 is responsible for hosting distributions. The code repository 164 may be implemented using well known components of hardware and software. Additionally, the code repository 164 can be or include one or more repositories hosting distributions. The distributions can include bundles of software that is already compiled and configured. The distributions may be in the form of either rpm, deb, tgz, msi, exe formats, and the like. For example, distributions may include bundles of software that comprise the operating system, and assorted other software. The distributions can take a variety of forms, from fully-featured desktop and server operating systems to minimal environments.

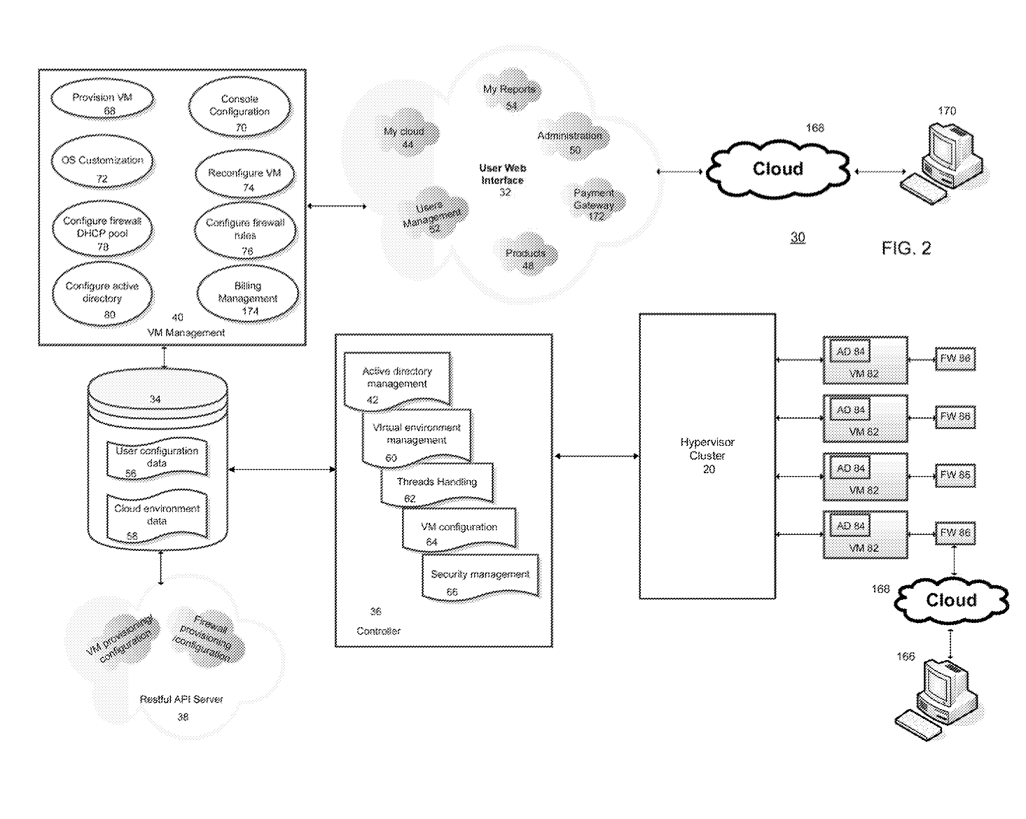

In one preferred embodiment, shown in FIG. 2, the system and method of the present invention are illustrated. In this system 30, a front-end interface 32 through which user using the presented GUI can interact with the application, and the back-end daemon controller 36 are used to synchronize the provisioning database 22, which comprises a distribution tree list 24 and template list 26.

As shown in FIG. 2, the system of the present invention preferably includes a GUI presented to the user's computer 170 over a network 168, which allows the user to interact with interface 32 to specify parameters for VM provisioning and directory attributes, such as related to: language selection; mouse configuration; keyboard selection; boot loader installation; disk partitioning; network configuration; NIS, LDAP, Kerberos, Hesiod, and Samba authentication; firewall configuration; and package selection.

In one embodiment of the system of the present invention, input from the user is converted to a task request which is prioritized according to the type of action requested. If the action requires changes at the database level, it will be completed immediately and will not be added to the task queue. Alternatively, changes at server level like provisioning, deprovisioning, power off or on actions, etc., will be added to the task queue in database 58 that the controller daemon 36 can execute. As is known in computer programming, a daemon is a program that runs unobtrusively in the background of Unix-like operating systems, waiting to be activated by the occurrence of a specific event or condition, such as the occurrence of specific time or date, passage of a specified time interval, a file landing in a particular directory, receipt of an e-mail or a Web request made through a particular communication line, rather than under the direct control of a user. Daemons accommodate requests for services from other computers on a network, and may respond to other programs and to hardware activity.

The present invention eliminates the need for direct communication between the interface 32 and the hypervisor cluster 20, thereby enhancing security. The user's requests are directed to the daemon's local database 34 to expedite the processing of the request thus there is no need to interact with the hypervisor cluster 20 each time the controller 36 requires data, such as retrieving a listing of the client VM's in response to a user's request received through the report function 54.

Further, the local database 34 reduces the load on the hypervisor cluster 20 for automated tasks such as billing and utilization reports. The daemon's database 34 is periodically refreshed from the data in the hypervisor cluster 20.

### System Overview

As shown in FIG. 2 the system 30 of a preferred embodiment of the present invention comprises a front-end web interface 32 which provides a GUI through the network 168 to the user's computer 170, with which the user can interact with the system, and the back-end controller 36 that controls all the processing functions relating to the VMs, Networks, and datacenters. All the user-selected actions that require changes at the hypervisor cluster 20 level, such as provisioning, deprovisioning, power actions etc., will be added to the task queue in database 58 that controller 36 can execute. If the task requires changes to be made at the database 34 level only, it will be completed immediately and will not be added to the task queue in database 58.

Controller 36 comprises server level software that runs in the background to complete fulfill the actions posted by interface 32. Controller 36 runs as a daemon on the server and can be started, stopped or restarted at any time. If controller 36 is not running, the tasks requested by interface 32 will not be completed and will be suspended in a waiting state until the controller 36 is restarted. Once controller 36 starts, it will check the actions queue in database 58 and will execute them one by one.

### User Interface

User interface 32 can be made available to many types of users including channel partners, embedded partners (vendors), private and public cloud users through the users management 52 module. Channel partners are partners who will drive more business by referring their customers to the hosting service. Embedded partners are partners that enable the host to deliver services using the partner's products. Public or private users are those users who register with the host for virtual desktops or servers 82. These users can be companies or individuals.

The system 30 may be used with a variety of hosted services including (i) hosted virtual desktop (ii) hosted virtual servers, and (iii) hosted security. These products can be managed through the products module 48. By using this module, users can choose among these products at the time of selecting preferences for provisioning VMs. The virtual desktops may include Windows and Linux based operating systems.

The hosted virtual servers may include Linux-based servers, and hosted security provides firewall-based security for client's hosted VMs. When a user orders VM provisioning or requests any service, Billing Management module 174 of VM management 40 requests payment from the user, including the input of billing information for payment directly by credit card through Payment Gateway 172 on interface 32. Once the payment process is complete, Billing Management module 174 of VM management 40 will generate a task based upon the user's order for controller 36, which is input into the task queue in database 58. Controller 36 then picks up a task from task queue and performs the required action posted by Billing Management module 174 and a status email confirming the completion of the task may be sent to the user by controller 36.

### My Cloud (Server Provisioning Inputs) 44

When a user orders a VM, the ordered VM can be accessible for provisioning from the My Cloud 44 selection in interface 32. On completion of VM provisioning from VM management 40, the status of VM is updated in My Cloud section 44. The My Cloud block 44 is a user specific interface that allows the user to perform different reconfiguration operations on existing VMs, such as i) Power on VM, ii) Power off VM, iii) De-provision a VM, iv) Upgrade/Downgrade of VM, v) Password protected Remote console viewing of VM, and vi) Change password operation for Remote console viewer.

When a user toggles a power on button of a VM, a task is generated in the database server 34 for powering on the user's selected VM. The controller 36 fetches the task from database 58. This task is controlled via Thread Handling module daemon 62 in order to monitor the task execution. The task is managed by VM configuration block 64 and executed by VM configuration block 64. Threads handling module 62 waits for the task completion and updates the task database 58 in the database server 34 on task completion. After task completion, My cloud interface 32 is refreshed to display the current of state of the VM to the user. The Power off, De-provision and Upgrade/Downgrade operations are automated in a similar execution flow as the Power on operation described above.

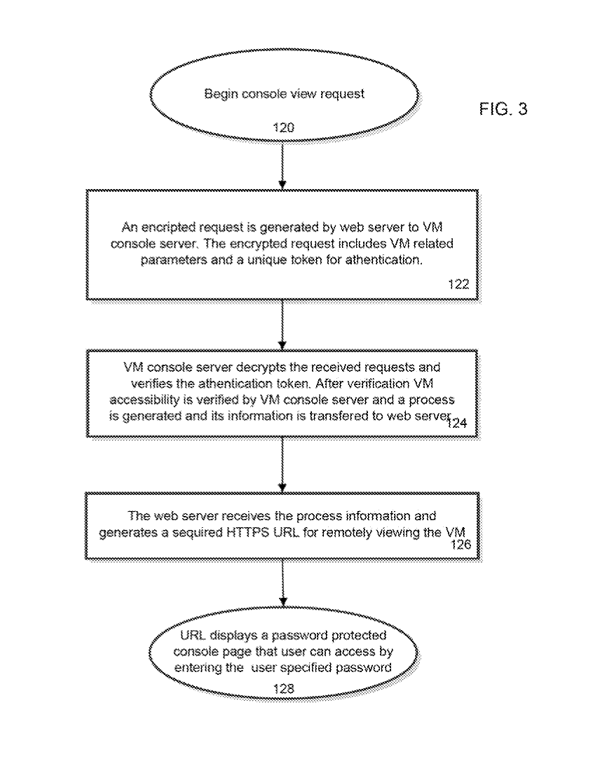

The My Cloud module 44 also provides the secured remote console viewing of as existing VM. FIG. 3 illustrates the process of VM remote console viewing. At step 120 a request for remote console view of the VM is generated when a user clicks on the button for console view in My Cloud 44. In step 122 the VM management module 40 transmits an encrypted request to the VM console server (not illustrated). At step 124 token based authentication is accomplished by the VM console server and verification of VM accessibility is completed with the hypervisor cluster 20. At step 124, a process is generated for the VM remote accessibility and web server is informed about the availability of the VM as to whether the VM is on or off, indicating whether its assigned user is operating the VM. In step 126, the web server gets the process information received from VM console server and generates a HTTPS URL request for remote viewing of the VM. In step 128 a web page is displayed for the user to enter the user specified password and to access the VM in the user's web browser.

My Cloud 44 allows the user to change the password for remote console viewing of a VM. The change password operation is executed by My Cloud 44 when the change password button is clicked. A task is generated in database 58 of the database server 34 for changing password on the user desired VM console view. The Controller 36 fetches the task from the database 58. This task is controlled via Thread Handling module 62 in order to monitor the task execution. The task is managed via VM configuration 64 in controller 36. Threads handling module 62 waits for the task completion and updates the database server 34 on task completion. VM configuration block 64 forwards the change password request to Console Configuration block 70 for actual change of password for remote console view.

### My Security Module

Another preferred embodiment of this system also may provide security features and network management for VMs. When a user orders a security feature enabled on a set of VMs, a firewall is provisioned for the user by modules 66 and 42. Once the firewall is provisioned, the user can view the firewall settings that have been automatically provisioned on the My Security selection within My Cloud 44 of the user interface 32. The automatic provision firewall preconfigures the firewall with basic default firewall rules, network address translations rules, and assigns private IP pools for the user VMs. The network assigned to the VMs is secured via the auto provisioned firewall.

My Security selection within My Cloud 44 of the user interface 32 allows the user to provide inputs to re-configure the firewall rules according user desired security concerns. All task generated from the user for re-configuration of firewall goes to database server 34. The Controller 36 fetches the task from the database server. This task is controlled via Thread Handling module 62 in order to monitor the task execution. The task is managed via Security management 66 in Controller 36. Threads handling module 62 waits for the task completion and updates the database server 34 on task completion. The block 66 forwards firewall reconfiguration requests to API calls available in block 42 “firewall provisioning”.

### Administration Panel

The system of the present invention 30 preferably includes a GUI-based Administration 50 panel that is at the highest security level because it allows control of datacenter settings, user management, products settings, and payment and billing options. The system configuration parameters, such as users' management, products managements, billing and pricing parameter, reports, and related parameters can be monitored and adjusted through module 50.

### Reports Module

Reports module 54 allows the user to generate different types of reports tailored to different types of users. For example, embedded partners may use Reports module 54 to review reports related to their products. For channel partners Reports module 54 provides the ability to run reports of products and services their customers request and the commissions that are generated from those sales. Additionally, private or public users may view reports of order history, invoices history, and system utilization.

### Database

The module database server 34 is used to store system data related to users in database 56 and cloud environment in database 58. Users data 56 includes user profiling, orders & invoices, user VMs, etc., and cloud environment data 58 includes information on host resources, such as datacenter location and capacities, clusters, networks, hosts, VMs, datastore, etc.

The communication among the system 30 modules is accomplished through database server 34. The actions and their statuses of the VMs are stored in database 58 of database server 34 for display at interface 32.

### Controller

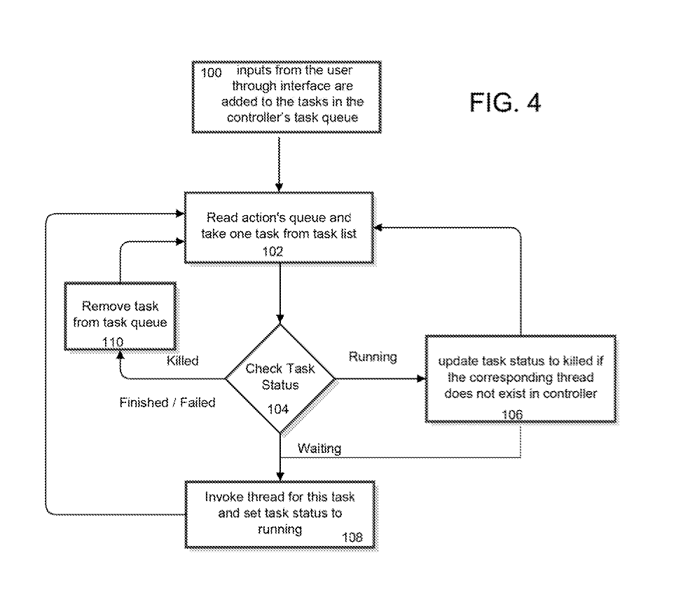

FIG. 4 illustrates the task management function performed by controller 36. At step 100, inputs from the user through interface 32 are added to the tasks in the controller's 36 task queue. Controller 36 then reads the tasks in the queue (step 102) sequentially and calls the appropriate handler thread on the basis of task status (step 104). Initially each task will be in the “waiting” state until controller 36 starts executing it and set its status to “running” at step 108. When controller 36 starts executing that task, status will change to running and then finished once completed (step 106). A task status can be finished/failed/killed depending upon whether it has been completed successfully or failed due to any reason. Controller 36 will remove that task from task queue (step 110) after updating logs and task status.

Controller 36 initiates different threads processes for handling requests coming from interface 32. Accordingly, at any time there can many threads running to performs the actions requested. Each of these threads are independent of each other and inter process communication is carried out through the database 58. The controller 36 will set the thread status to finish on its completion and if any problem occurs the status will be set to “failed.”

All the threads have been handled for exceptions so that they can set their status according to the situation. Controller 36 accesses data stored in its local database 58 for calculations to be performed such as selecting the datastore in the hypervisor cluster 20 to be allocated at time of VM provisioning, available resources on physical host, the number of available network, and similar data as needed for decisions such as provisioning allocations. Accordingly, controller 36 has threads that actually interact with hypervisor cluster 20 through API calls to fetch the required data and store it in local database for further needs. Controller 36 executes these threads from time to time to refresh the data elements in the database 58.

Among the controller 36 threads, are threads for provisioning that automate VM provisioning 68, firewall provisioning 42 on the basis of datacenter selected by the user. Controller 36 generates unique names for VMs depending upon the user type, such as whether it is company user or an individual user. Next, controller 36 calculates the allocated storage location cluster in hypervisor cluster 20 on the basis of the selected datacenter, and the physical host is picked up in that cluster automatically so that no user involvement is required to complete this process.

Controller 36 automatically implements predefined default resource allocations for VMs according to user type. These default provisioning allocations include, for example, network assignment, “Vlanld”, VM console port, network configuration, and OS installation & configuration.

Controller 36 will generate a confirmation email to the user upon successful completion of the requested provisioning. Alternatively, in the case of a provisioning discrepancy, such as a user requesting a greater number of VMs than the host is currently able to support, or with capabilities, such as software programs that the host does not offer, controller 36 will generate an email or other alert to the host operator so that the issue can be resolved and the user's request can be provisioned.

### Virtual Environment Management Block

The Virtual Environment Management block 60 provides handling of all calculations and environment identification required for VM configuration, such as CPU memory allocation. This module also updates cloud environment data 58 in database server 34. Virtual Environment Management block 60 performs the replication of Cloud environment for where VMs exist. The cloud environment includes datacenters, data stores, clusters, host servers and all components of VMs that exist in the Cloud. The components of the VM includes hard disks, RAM, video memory, CD/DVD ROMs, Ethernet cards, VM network, VM Network settings and the operating system associated with the VM.

Virtual Environment Management block 60 performs the identification and tagging of the assigned cluster based on the user type provided in VM provisioning request by the Products interface 48. In this process, separate clusters may be allocated to corporate users and individual public users. Once the cluster is identified for the user, controller 36 will identify a hypervisor server from hypervisor cluster 20 so that a VM can be provisioned on it. After the identification of a hypervisor server for the VM, Virtual Environment Management block 60 identifies the datastore associated with the Host and selects the assigned datastore based on the product type, such as whether the user has requested a Hosted Virtual server or Hosted Virtual Desktop. Virtual Environment Management block 60 also manages the identification of Public and Private Clouds based on the type of user who has initiated the task for the VM provisioning or configuration.

For a company based user, Virtual Environment Management block 60 identifies an unassigned “Vlan id” for the private network that is to be used in network configuration for the VMs. This “Vlan id” is selected from the “Vlan id” pool that is managed by the Virtual Environment Management block 60. This pool is managed in cloud environment data 58 stored in database server 34.

Virtual Environment Management module 60 is responsible for calculation of remote console configuration port number. This remote console configuration port number is uniquely calculated when a VM provisioning is requested. The calculation of remote console configuration port number is done according to the hypervisor cluster 20, where VM is provisioned.

### VM Configuration Module

VM configuration module 64 provides handling of all task related to VM management module 40. Module 64 generates request to the API calls available in block 40 and notifies the Controller block to update the database management block 34 for the task completion and the status of the task. VM configuration module 64 also manages the provisioning of the VM. VM configuration block 64 is responsible for reconfiguration of existing VMs. Reconfiguration operations that are handled by this block are upgrade/downgrade of VM Memory, Video Memory and CPU. Block 64 also handles the Add/Remove operation Hard Disk, and Ethernet cards. Block 64 performs re-configuration of CD/DVD Rom to new ISO images.

All the operations handled by VM configuration module 64 are forwarded to blocks 68, 74 and 72 for complete VM management. All task requests for this block are initiated by blocks 44 and 48 in the user interface 32, or 38 in Restful APIs.

### VM Management Module and Provision VM Block

The VM Management module 40 is responsible for provisioning and managing VMs in the cloud. Provision VM 68 performs API calls to Esxi Host in Datacenter for provisioning of VM. The module 68 is controlled by Controller module that automates the provisioning process. Provision VM block 68 is responsible for auto-assignment of Virtual machine name configuration. The Name for the VM is calculated by Controller module 36. Provision VM block 68 is responsible for configuration of the VM hard disk, CD/DVD Rom and Ethernet card.

The system of the present invention 30 provides automatic network configuration of the VM at the time of provisioning via Provision VM block 68. The network for VM is identified by the Controller 36 and programmed to the VM at the time of provisioning.

The system of the present invention 30 provides functionality of remote viewing of VM via configuration of remote console viewing on VM. This console configuration is done automatically via block 70, at the time of VM is provisioning. The calculation and management of remote console configuration port for accessing the VM remotely is done by Controller module 36 and then an instruction is executed to VM Management block 40 for auto configuration of Virtual machine with remote console based viewing.

The system of the present invention 30 automates VM operating system installation. The template assignment done in block 68 helps in automated installation of Operating system selected by the user.

### Reconfigure VM Block

The Reconfigure VM block 74 in module 40 allows the Controller module 36 to perform auto re-configuration operations on existing VMs. Block 74 can reconfigure VM network, upgrade the hard disk of VM, upgrade and downgrade the RAM and CPU count of VM, can add/remove new hard disk to VM, can add/remove Ethernet cards to VMs, add new CD/DVD drives to VM, Reconfigure CD/DVD drives with ISO images from application store and update the memory of video card in VM.

### VM Management Module and OS Customization Block

VM Management module 40 provides automated customization of VM operating system via OS customization block 72. OS customization block 72 automatically assigns the computer name of the VM according to the user type and allows changing the password of operating system according to user preference. The OS customization module automates configuration of the operating system network settings based on the user type, including DHCP pool settings in case of private company based users (i.e. With orders of Hosted Virtual Desktops) and fixed public IP settings in case of public users (i.e. With orders of Hosted Virtual Servers). The OS customization block 72 also automates the configuration of time zone settings according to user preferences at the time of VM provisioning.

Once provisioning and configuration of VM is completed, the VM configuration block 64 generates an email notification to the user and administrator. Once the user gets notified for the VM provisioning process completion, the “My Cloud” section 44 in Interface 32 displays all the VMs to the user with powered on status. Now the user can perform different operations on his VM.

### Automatic Firewall Provisioning

Security Management module 66 provides automatic handling of all tasks related to Firewall management. Security Management block 66 generates request to the API calls available in block 42 to perform firewall provisioning. This block 66 handles the auto configuration of dynamic host configuration protocol (DHCP) pool generation and configuration in the Firewall. This block also handles the firewall configuration requests and network address translation request. The purpose of this block is to perform all security related configuration of firewall.

All the operations handled by Security Management module 66 are forwarded to block 76 and 78 for complete firewall provision and configuration. All task requests for this block are initiated by block 46 in the user interface 32, and 38 in Restful APIs.

The system of the present invention provides security by auto provisioning of virtual firewalls for VMs 82 for each new customer. This security management module 66 performs auto-provisioning of virtual firewall VM templates for each customer. During the provisioning process, the security management module 66 assigns six virtual Network interface cards to each firewall for configuration of public internet protocol addresses on Ethernet Zero inside the firewall. The security management module 66 also assigns private IP addresses to Ethernet1 which segments the public internet from the internal network. The Configure firewalls rules block 76 gives users the required configuration with the desired private network that is needed to assign Internet protocol addresses to VMs 82. The Configure firewall DHCP pool 78 takes the inputs from The Configure firewalls rules block 76 to configure dynamic host configuration protocol to distribute IP addresses to all VMs that are hosted within the virtual private Datacenter. By automation and creation of the Firewall, users will have the ability to manage the firewall under the My Security section within My Cloud 44 of the user interface 32. This My Security section has three further sub-sections i.e. Ports, IP Addresses and VPN.

### Ports:

Under the Ports function, users will be able to create Network address translations to allow VMs 82 to open up UDP and TCP protocols on a specific VM 82. An example would be a web server. The execution of this configuration is made by an API call that is sent by Controller 36 to the public IP address on the firewall 86 on Ethernet Zero. This configuration is then saved in the User Configuration Database 56 and in the Cloud environment Database 58 as well.

### IP Addresses:

Under the My Security section within My Cloud 44 of the user interface 32, a user is able to add additional public internet protocol addresses by clicking on a menu button designated “Buy IP.” Once an Internet Protocol address is purchased, the Database for User Configuration database 56 and the Cloud Environment Database 58 are updated with the newly purchased Internet protocol address. The Controller 36 will receive purchased Internet Protocol address information from Cloud Environment Database 58 and will automatically configure that IP address for the firewall 86 by making API calls to Ethernet Zero on the firewall 86. The second function of IP addresses Management is to allow users to be able to configure up to five IP address Networks.

Under My Cloud's My Security section a user is also able to add Internal private IP network. This process is as follows. Under Internal IPs section within My Security's IP addresses feature, a user clicks on a menu button designated as “Add Network” to configure the internal private Inter protocol addresses. A form pops up asking the user to provide Network configuration settings. This form will auto-complete with the starting IP address range that will be assigned to the next available 5 network interfaces on the Firewall. The user will then enter IP addresses with the Subnet Mask. The next step for the user is to click on the “load” menu button and finally the “save” menu button to save the settings. Once the configuration is saved, the User Configuration database 56 is updated with the newly configured IP addresses and the Cloud Environment database 58 is also updated. The Controller 36 will receive the newly configured Internet Protocol addresses from Cloud Environment Data 58 and it will automatically configure them by making API calls to Ethernet Zero on the firewall to execute the configuration on the next available Ethernet interface.

### VPN:

Under the VPN function within the My Security section within My Cloud 44 of the user interface 32 a user is able to configure a site-to site VPN. This will allow a user to establish communication between his Virtual cloud function within My Cloud 44 of the user interface 32 to any other location that supports site-to-site VPN configuration. On the VPN configurator, under My security, a user clicks on the “Add Network” menu button. A Popup form will ask the user to input following information:
VPN Name Location—This identifies the VPN name
Source VPN IP—This is grayed out by default. The source IP is on the interface zero of the firewall.
Destination IP is the remote site.
Pre-Shared Key is a shared password between VPN tunnels sites
Local Subnet is the local Internet protocol address that was configured on the firewall
Remote Subnet is the private Internet protocol address on the remote site
ESP Policy & IKE Policy—These are security parameters and can be set as low, Medium or High
   Once it is saved, the User Configuration Database 56 is updated with the newly configured VPN tunnel and it also updates the Cloud Environment database 58. The Controller 36 will receive the newly configured VPN tunnel from Cloud Environment database 58 and it will automatically configure the VPN tunnel by making API calls to Ethernet Zero on the firewall 86 to execute the user's desired configuration.

Once provisioning and configuration of firewall is completed, the VM configuration block 64 generates an email notification to the user and administrator. Once the user receives notification of the firewall provisioning process completion, the “My Security” selection within My Cloud 44 of the user interface 32 displays all the firewalls to the user with powered on status such that the user can perform different operations on the firewall.

### My Cloud

My Cloud 44 displays a list of Virtual Machines 82, Active Directory Servers 84 and Firewalls 86. Once the machine is available, the user can use its machine for operations supported by the virtual machine

My Cloud 44 allows the user to re-configure the firewall rules according user desired security concerns. All task generated from the user for re-configuration of firewall goes to DB server 34. The Controller 36 fetches the task from DB server. This task is controlled via Thread Handling module 62 in order to monitor the task execution. The task is managed via Security management 66 in Controller. Threads handling module 62 waits for the task completion and updates the DB server 34 on task completion. The block 66 forwards firewall reconfiguration requests to API calls available in block 40.

### Administration 50

### Active Directory Management

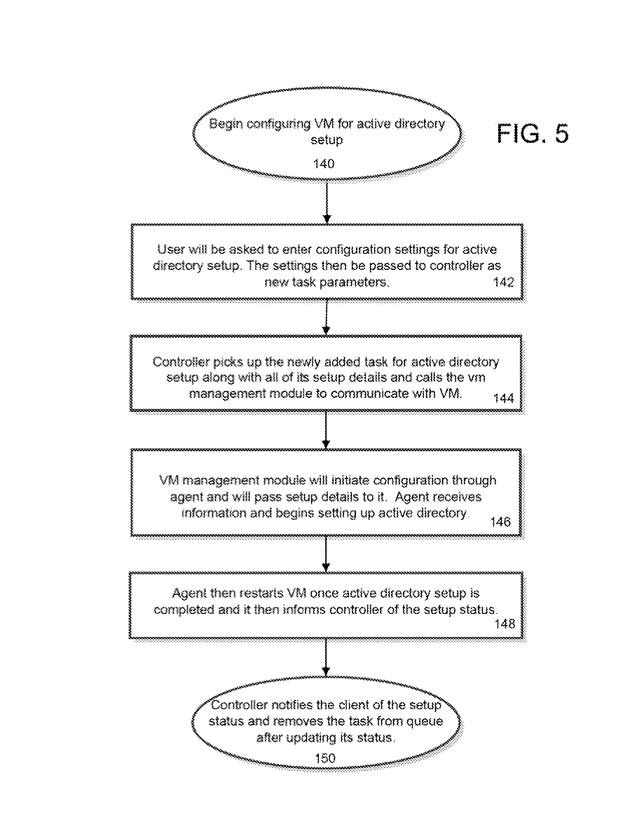

In My Cloud interface 44, the user has an option of configuring a Hosted Virtual Server as an Active directory server. FIG. 5 illustrates the process for active directory setup. A user can configure an existing server as active server by clicking on the active directory button 140. The user is then prompted for the active directory setup information 142. Once the information is received, a task is generated in the database server 34. The Controller 36 fetches the task from database server 34 at step 144. This task is controlled via Thread Handling module 62 in order to monitor the task execution. The task is managed via Active Directory Management 42 in Controller 36. This block 42 fetches setup information from database 34 and forwards it to block 40 in order to configure active directory using block 80 as described in 146. As shown in step 148, block 80 then communicates with the selected hosted VM agent 84 to configure the active directory server, and then restart the VM after notifying Thread Handling module 62. After task completion, the database 34 is updated by the controller 36 as shown in step 150, and the user is notified of the successful VM domain configuration.

In a preferred embodiment of the present invention, the user is provided with the ability to directly manage the directory allocation functions for one or more VMs under the user's operational control. An exemplar application of this function is illustrated by the use of the present invention for VM hosting systems using Microsoft Windows 2008, 2003 and 2000 servers and Windows 7 desktops. The system of the present invention comprises an active directory management block 42 in the controller module 36. The active directory management block 42 uses the directory selection inputs from the user in the Users Management 52 function in the User Interface 32, which are stored in the User Configuration data files 56 in the database 34. The active directory management block 42 automatically inputs these selections into the server active directory function 84 of the VM 82, for example Microsoft's Active Directory program for Microsoft Windows 2008, 2003 and 2000 and Windows 7 programs. The active directory management block 42 also automatically inputs these selections into the operating systems in the VMs 82, such as for example, in the Microsoft Active Directory program for each of the VM's Microsoft Windows 2008, 2003 or 2000, or Windows 7 operating systems programs.

As is known in the art, Microsoft's Active Directory program is used to implement directory services for Microsoft Windows 2008, 2003 and 2000 servers, and Windows 7 operating systems including integration of the directory services to Windows domains and Domain Name Service (DNS). The core unit of logical structure in the Active Directory is the domain, which can store millions of objects. Objects stored in the domain identify printers, documents, e-mail addresses, databases, users, and other resources. All network objects exist within a domain and each domain stores information only about objects it contains. A domain is an administrative boundary, a security boundary, and represents a name space that corresponds to a DNS domain.

The first domain created is called the root domain, which is organized in a hierarchy. The concepts of forests and trees are a part of these domains. A domain tree is formed as soon as a child domain is created and associated with a given root domain. A domain tree looks like an inverted tree (with the root on top), with branches (child domains) sprouting out below. Trees are the structural elements that ensure the scalability of the Active Directory. As each domain is a partition (part of the entire directory), trees allow the hierarchical structure necessary for organizations, much like DNS domain structure does for the Internet. Active Directory domain names are the same as the DNS domain names. There are cases where two or more domain trees, each represented by separate DNS name space, need to be included as one enterprise. A tree must be represented by a contiguous DNS name space and disallow participation of domains that are not within its name space. The mechanism for connecting one or more trees is the Forest. All trees within a forest share the following attributes:
Common Schema
Common Configuration (AD infrastructure information)
Global Catalog

The Global Catalog (GC) dictates the data definitions for the Active Directory. If an object or attribute is not in the GC, that object/attribute will not be stored in the Active Directory. The directory contains information in the form of objects and object attributes. The directory is a database that is optimized for querying. Data that is more or less static and is searched often can be beneficially stored in the directory. Data that changes often is not a good choice for storage in the directory. For example, user properties such as phone number, building number, pager number, and application configuration data are examples of information that can be effectively managed by directory services, as these types of data are fairly static. These types of data are queried much more often than they are changed. System logs and file systems are not good candidates for the directory as, these data are extremely dynamic.

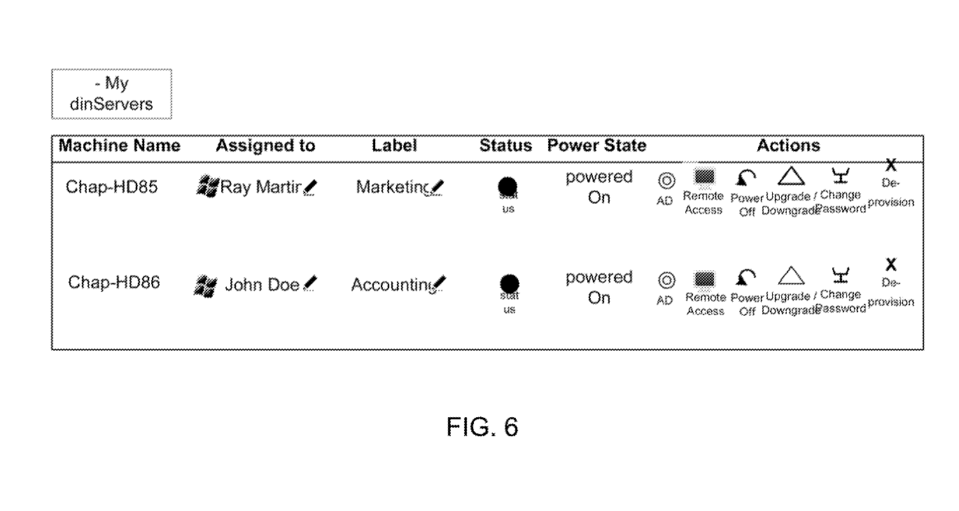

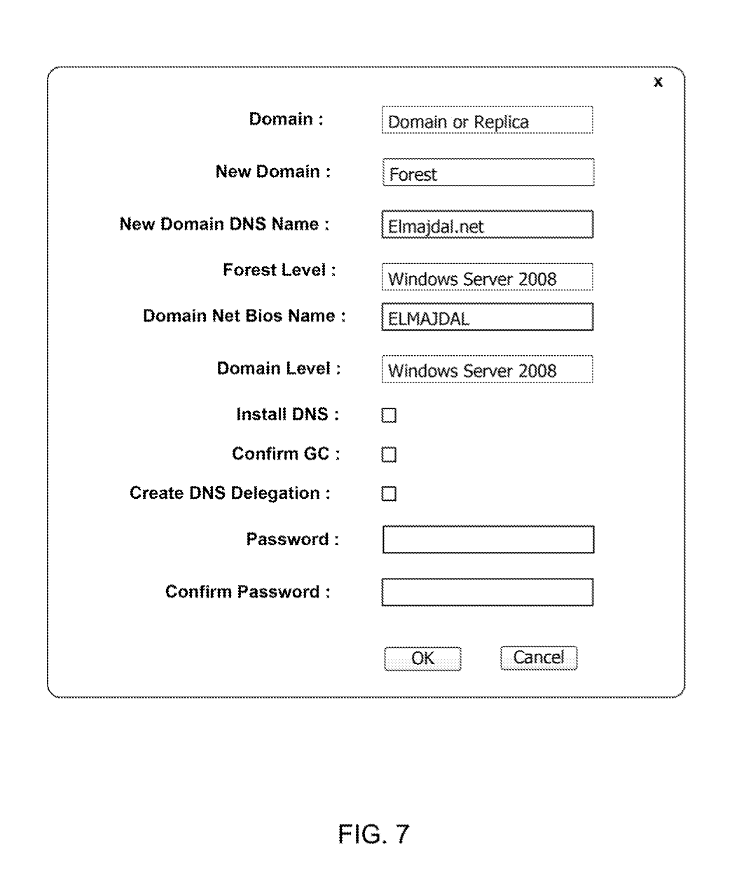

The My Cloud GUI illustrated in FIG. 6 allows the user to select from list of VMs ordered by user. The user may select one, all, or any desired combination of the VMs in the user's account. After selection of the specific VMs to be assigned the selected directory configurations, the user clicks on the “Windows” icon to access the Active Directory functions. This will brings up the GUI illustrated in FIG. 7. As illustrated in FIG. 7, the Active Directory GUI allows the user to input the following directory parameters:

| Parameter: value | Description |
|---|---|
| Domain: | Specifies whether to continue installing this domain |
| | controller, despite the fact that another domain controller |
| | account with the same name is detected. Domain is used |
| | only if the account is not currently used by another domain |
| | controller. |
| Domain or Replica | Replica specifies that an existing domain is recreated, and |
| | skips the automatic configuration of DNS client settings, |
| | forwarders, and root hints. This parameter is in effect only |
| | if the DNS Server service is already installed. |
| New Domain | Specifies the application directory partitions that dcpromo |
| | will replicate. |
| New domain DNS name | Specifies the single-label Domain Name System (DNS) |
| | name of the child domain. |
| Forest Level: | Specifies the forest functional level when you create a new |
| Windows 2000, Windows | forest. A value of 0 specifies Windows 2000. A value of 2 |
| Server 2003, Windows | specifies Windows Server 2003. A value of 3 specifies |
| Server 2008 | Windows Server 2008. A value of 4 specifies Windows |
| Windows Server 2008 R2 | Server 2008 R2. |
| | The default forest functional level in Windows Server 2008 |
| | when you create a new forest is Windows 2000 (0). |
| The default forest functional | The default forest functional level in Windows Server 2008 |
| level is Windows Server | R2 when you create a new forest is Windows Server 2003 |
| 2008 | (2). |
| | The default forest functional level in Windows Server 2008. |
| | This parameter is not used when installing a domain |
| | controller in an existing forest. |
| Domain Net Bios Name | Assigns a NetBIOS name to the new domain. |
| Domain Level: | Specifies the domain functional level during the creation of |
| Windows 2000, Windows | a new domain. A value of 0 specifies Windows 2000. A |
| Server 2003, Windows | value of 2 specifies Windows Server 2003. A value of 3 |
| Server 2008 | specifies Windows Server 2008. A value of 4 specifies |
| Windows Server 2008 R2 | Windows Server 2008 R2. |
| | The domain functional level cannot be lower than the forest |
| | functional level, but it can be higher. |
| | The default is automatically computed and set to the |
| | existing forest functional level or the value that is set for |
| | /ForestLevel. |
| Install DNS: {Yes\|No} | Specifies whether the DNS Server service should be |
| | installed. The default is automatically computed based on |
| | the environment. |
| Confirm GC: {Yes\|No} | Specifies whether the user wants the domain controller to |
| | be a global catalog server. |
| CreateDNSDelegation: | Indicates whether to create a DNS delegation that |
| {Yes\|No} | references the new DNS server that the user is installing |
| | along with the domain controller. Valid for Active Directory- |
| | integrated DNS only. |
| | The default is computed automatically based on the |
| | environment. |
| Password | Specifies the password that corresponds to the user name |
| | (account credentials) that is used to install the domain |
| | controller. |
| Confirm Password | Confirms the password for creating DNS delegation. |

The Domain/replica input menu allows the user to designate the VM as “domain controller,” or as replica to join an existing domain.

The New Domain input menu established a DNS log on address for user. The Domain Name System (DNS) is a hierarchical distributed naming system for computers, services, or any resource connected to the Internet or a private network. It associates various information with domain names assigned to each of the participating entities. A Domain Name Service translates queries for domain names (which are meaningful to humans) into IP addresses for the purpose of locating computer services and devices worldwide. For example, the Domain Name System translates human-friendly computer hostnames into IP addresses. The Domain Name System makes it possible to assign domain names to groups of Internet resources and users in a meaningful way, independent of each entity's physical location.

The Forest Level input menu allows selection of the level of the server which will be assigned to resources using the forest, for example a Microsoft Windows 2008, 2003 or 2000 server. As is known in the art, these servers are backwards compatible, such that a Microsoft Windows 2008 server can provide resources which can be used by Windows 2003 or 2000 applications, but not vice-versa.

The Domain Net Bios Name input menu allows selection of a NetBIOS name for the new domain which may be used to browse the network on Windows 7 f The Domain level input menu allows selection of server level of Windows 2008 or 2003, 2000

The Install DNS input menu allows selection of DNS services to resolve DNS names to an IP address.

The Confirm GC Global catalog server, installs backup directory services database: primary secondary

The Create DNS delegation input menu allows multiple DNS servers by allowing the server to delegate database to other servers hosting DNS.

### The VM Management Module

The Active Directory management block 42 of the VM management module 40 stores the user inputs for the directory configuration for the designated VMs in the user configuration data file 56 in the database 34.

The daemon in the controller 36 is programmed to periodically poll the database 34 for any new data updates since the previous poll. Upon detecting that any data objects relating to VM directory configuration have been updated, Active Directory management block 42 of the controller 36 generates a queue for the Active Directory agent 84 in each VM 82 affected by the new configuration data. This queue will instruct the Active Directory agent 84 in each VM 82 to update the active directory configuration data in the Windows 7 or other operating system program used by the VM 82.

### Agent

The Active Directory agent 84 in each VM 82 is programmed to periodically call in to the Active Directory management block 42 of the controller 36 to check for queues containing instructions to download updated configuration data objects, including domain name services. These daemon queues relate to data stored in the user configuration data portion 56 of database 34. The Active Directory agent 84 inputs the identified configuration data into the active directory configuration database in the Windows 7 or other operating system program used by the VM 82 by executing Dcpromo.exe parameters, such as “/uanattend.” This command specifies an unattended installation in which the installation parameters and values are specified at the command line of the instruction.

### RESTful API Module

This system of the present invention 30 may also provide all of its functionality via RESTful API calls made from public or private users. Similar to the web-based user interface 32, the RESTful API server 38 also allows a user to i) provision a VM, ii) view available products lists, iii) Upgrade/Downgrade virtual machine software and memory allocations, iv) provision the virtual machine, v) control the Power on/Power off function for a virtual machine, vi) De-provision a virtual Machine vii) Create a firewall viii) Configure a firewall ix) view a Datacenter list x) view VM resource information, and xi) obtain a remote console view of a selected VM.

The flow of information and requests through the API is similar to the user web interface 32 as described in the above embodiments. All tasks requested are stored in database 58 of database server 34. Controller 36 then fetches each task. Each task is then controlled and managed by the different controller modules as described above, and then forwarded to the RESTful API server 38.

Initially the configuration file is read and depending upon whether there is a start stop in the configuration file, a check is made to see if the application is running and, if not, the instruction is stored or executed.

The user interface is connected to the server by a data transmission link, such as the Internet, or other electronic file transfer protocols such as FTP, SFTP, FTPS, HTTP, HTTPS, TELNET, SSH, XML, REST, or JSON as examples.

### Analytical Performance Reports

Agent 84 installed on each of the VMs 82 polls the daemon controller 36 for pending requests on 1 hour interval. Agent 84 also periodically sends data related to usage of software by the VM 82 to the daemon controller 36 for storage. The virtual environment management module 60 directs the storage of this analytical information in the cloud environment database 58 for later retrieval by the user in the form of analytical reports.

This information transmitted by the agent 84 includes which applications installed in VM 82, such as Office, Outlook, or an alternative indication if nothing has changed since last update. This information can be presented to the user through the user interface 32, and includes the identification of programs installed manually by the VM user or by the host according to initial provisioning instructions provided by the user, and allows confirmation that license obligations are fulfilled by the host for provisioned software.

The application performance and usage reporting also allows monitoring of the utilization of individual licensed programs for determining appropriate allocation of software licensing resources. It also tracks program operation in terms of how quickly each program opens from the “start” command in seconds, and how often each program crashes.

What is claimed is:

1. A system for assigning directory attributes, including domain name services, for virtual machines by a user over a network comprising:
an input server connected to a network and having a memory which includes computer program instructions, which when executed, perform steps of:
presenting an interface to a user over a network, the interface configured to receive inputs from the user comprising directory attributes, including domain name services, for a virtual machine; and
storing the input directory attributes in a database;
a database in communication with the input server for storing the directory attributes;
a controller in communication with the database and having a memory which includes computer program instructions, which when executed, perform steps of:
periodically polling the database for updates to directory attributes since the previous poll; and
creating and storing a daemon thread which identifies the virtual machine and the updated directory attributes; and
a directory agent associated with the virtual machine in communication with the controller and having a memory which includes computer program instructions, which when executed, perform steps of:
periodically polling the controller for daemon threads; and
inputting the identified updated directory attributes into the operating system program of the virtual machine.

2. The system of claim 1 wherein the input server program instructions comprise the step of presenting an interface to the user with the option to select a plurality of virtual machines for which the directory attributes are assigned.

3. A system for assigning firewall resources from a firewall server for virtual machines comprising:
an input server connected to a network and having a memory which includes computer program instructions, which when executed, perform steps of:
presenting an interface to a user over a network, the interface configured to receive inputs from the user comprising firewall attributes for a virtual machine; and
storing the input firewall attributes in a database;
a database in communication with the input server for storing the firewall attributes;
a controller in communication with the database and having a memory which includes computer program instructions, which when executed, perform steps of:
periodically polling the database for updates to firewall attributes since the previous poll; assigning available IP addresses to new firewall requests based upon the next available IP address stored in the database;
sending API calls to a firewall server with the hard coded IP address to associate a free IP address obtained from the database to the firewall server to generate firewall clones for the virtual machine; and
sending API calls to a firewall server to provide firewall configuration updates to the firewall server clone; and
a firewall server in communication with the controller to receive the API calls.

4. The system of claim 3 wherein the input server program instructions comprise the step of presenting an interface to the user with the option to select a plurality of virtual machines for which the firewall resources are assigned.
